(19) United States
(12) Patent Application Publication
(10) Pub. No.: US 2002/0127358 A1
(43) Pub. Date: Sep. 12, 2002

(54) BIODEGRADABLE PACKAGING LAMINATE, A METHOD OF PRODUCING THE PACKAGING LAMINATE, AND PACKAGING CONTAINERS PRODUCED FROM THE PACKAGING LAMINATE

(76) Inventors: MIKAEL BERLIN, LUND (SE); KARIN HENNINGSSON, MOLNDAL (SE)

Correspondence Address: BURNS DOANE SWECKER & MATHIS L L P, POST OFFICE BOX 1404, ALEXANDRIA, VA, 22313-1404, US

(21) Appl. No.: 09/254,144

(22) PCT Filed: Sep. 1, 1997
(86) PCT No.: PCT/SE97/01462

(30) Foreign Application Priority Data
Sep. 4, 1996 (SE) 9603211-5

(51) Int. Cl. B32B 27/30; B65D 65/46; B65D 65/40

(52) U.S. Cl. 428/36.6; 428/36.7; 428/483; 428/481; 428/511; 428/336; 428/520; 427/411; 427/412.1; 427/420; 264/171.13; 264/173.11; 156/324

(57) ABSTRACT

Packaging laminate for packages for liquid foods having excellent liquid and oxygen gas barrier properties in which all included layers are biodegradable. The packaging laminate includes at least one liquidtight layer (11, 13) of homo or copolymers of monomers selected from a group consisting of lactic acid, glycol acid, lactide, glycolide, hydroxy butyric acid, hydroxy valeric acid, hydroxy caproic acid, valerolactone, butyrolactone and caprolactone, as well as an oxygen gas barrier layer (12) of ethylene vinyl alcohol, polyvinyl alcohol, starch or starch derivatives. The oxygen gas barrier layer is preferably applied by a dispersion coating process. The layers may be laminated directly to one another or indirectly by means of interjacent adhesive layers. The packaging laminate may also include a core layer of, for example, paper or paperboard, or a biopolymer. The invention also realises a method of producing the biodegradable packaging laminate according to the invention.

### TECHNICAL FIELD

The present invention relates to a packaging laminate comprising at least one liquid-tight layer and one oxygen gas barrier layer. The present invention also relates to a method of producing the packaging laminate and to liquid-tight packaging containers which are produced from the packaging laminate and which possess superior oxygen gas barrier properties.

### BACKGROUND ART

Use has long been made in the packaging industry of packages of the single-use type (so-called single-use disposable packages) for packing and transporting liquid foods. Such single-use disposable packages are often manufactured from a flexible material which, by forming and sealing, have been converted or reformed into filled, sealed packaging containers of the desired configuration.

One large group of packaging laminates for such single-use disposable packages consists of plastic films and plastic bags of different types comprising outer, liquid-tight layers of, for example, polyethylene or polypropylene.

Another major group of packaging laminates for such single-use disposable packages moreover includes a core layer of paper or paperboard.

The composition of such packaging laminates is intended to impart the best possible product protection properties to the packed product, at the same time as to render the package easy to produce and easy to handle. A core layer of paper or paperboard gives the package good mechanical configurational stability, such that the package may be distributed and handled in a simple, rational manner. The outer, liquid-tight coatings of, for instance, polyethylene, protect the core layer against moisture and liquid.

Depending upon storage time and the type of product which is to be packed, the packaging laminate may also include different metal layers or plastic layers possessing barrier properties vis-a-vis light or gases, such as, for example, oxygen gas.

Such packaging containers are often produced in that a web of the packaging laminate is reformed into a tube by the longitudinal edges of the web being united to one another, whereafter the tube is filled with the intended contents and is thermosealed along narrow, transverse mutually spaced apart sealing zones. The portions of the tube which are thus sealed off from one another and contain their intended contents are thereafter separated from the rest of the tube by means of incisions in the sealing zones and are formed, possibly by folding, into optional geometric configuration, depending upon how the sealing joints or seams are oriented.

One common and efficient oxygen gas barrier material is aluminium which, in the form of a foil (so-called Alifoil), may be provided in a packaging laminate. The use of Alifoil entails, however, a number of drawbacks. Because of its poor flexibility, flexural and tensile cracks occur in the fold regions in a fold-formed package, with the result that the packaging container is untight to penetrating oxygen gas. In addition, Alifoil is difficult to handle on recycling or incineration of the packaging material, and so consumed packaging containers will thereby be less environmentally friendly.

As stricter requirements are placed on the economic management in raw materials exploitation and on increased recovern and reuse of consumed packages, materials research and development in the packaging industry has been increasingly focused on producing and developing packaging materials which, to a higher degree than previously, make for an ecological and environmentally friendly production and recycling/recoverv of packages, without neglecting the requirement on the product protection properties and convenience of handling and use of the package itself. In line with this development trend, interest has been particularly focused on biodegradable or compostable polvmers, so-called biopolymers, and similar materials from renewable raw material sources as substitute materials for the previously employed petroleum-based plastics such as polyethylene.

In order to avoid the above-outlined drawbacks inherent in Alifoil, oxygen gas barriers of polymer materials may instead be employed, such as, for example, ethylene vinyl alcohol (EVOH), polyvinyl alcohol (PVOH), polyethylene terephthalate (PET), or polyamide.

In the attempt to achieve biodegradability, PVOH, EVOH starch or starch-based polymers are best suited as oxygen gas barrier materials. However, these materials suffer from drawbacks in the form of poor adhesion properties to adjacent layers in a packaging laminate, and high sensitivity to moisture. Under the action of moisture or liquid, the oxygen gas barrier properties in a layer of e.g. PVOH or starch drastically deteriorate, for which reason these layers in a packaging laminate must be surrounded by liquid-tight layers of, for example, polyethylene according to known techniques.

The expressions “biodegradable” and “compostable” are equivalent in content and imply that a material which is exposed to micro-organisms freely occurring in nature are readilv degraded (composted) into their naturally occurring components without environmentally unacceptable substances being formed and without the addition of hazardous chemical substances. It is desirable that such materials, under natural conditions, are broken down to their naturally occurring components in a quantitv corresponding to at least 70 per cent, more preferably at least 80-90 percent, and most preferably approximately 100 percent.

Such a level of biodegradability of at least 70 percent, more preferably at least 80-90 percent and most preferably up to 100 percent has, however, hitherto proved impossible to achieve for packaging materials which satisfv the requirements on oxygen gas tightness as well as liquid tightness.

In, for example, EP 514137 and in Swedish Patent Application No. 9501488-2, different biodegradable packaging laminates are described which comprise a core layer of, for example, paper and outer layers of a biodegradable polvmer. However, these packaging laminates entirely lack oxygen gas barrier properties.

A further drawback inherent in the prior art packaging laminates of biopolymer layers and other layers is that the internal bonding strength between the laminate lavers is unsatisfactory and often insufficient to reliably hold together the individual material layers in a well-integrated laminate structure, as is necessary in order that the packaging laminate is not to delaminate or otherwise be damaged during the service life of the packaging laminate in a package.

Hence, it has hitherto been difficult according to prior art technology to produce a biodegradable or compostable packaging laminate possessing superior internal bonding strength between individual material layers in the packaging laminate structure. In particular, it has proved difficult to bond together with good bonding strength the outer biodegradable layers to interjacent layers, whether or not the layers are laminated directly to one another or by the intermediary of a bonding layer of a biodegradable adhesive.

### OBJECTS OF THE INVENTION

One object of the present invention is therefore to realise a novel packaging laminate of the type described by way of introduction without inherent problems of the type intimately related to the prior art technology.

A further object of the present invention is to realise a packaging laminate possessing superior liquid- and oxygen gas barrier properties in which all component parts included are biodegradable and thus compostable.

Yet a further object of the present invention is to realise a biodegradable packaging laminate comprising an oxygen gas barrier layer and outer, liquid-tight lavers with improved adhesion or bonding betveen the layers included in the packaging laminate.

Still a further object of the present invention is to realise a biodegradable packaging laminate comprising an oxygen gas barrier laver possessing improved retained oxygen gas barrier properties on the action of moisture and liquid.

Yet a further object of the present invention is to realise a biodegradable packaging laminate possessing superior liquid- and oxygen gas barrier properties which moreover possesses superior thermosealing properties.

Yet a further object of the present invention is to realise a method of producing a liquid-tight biodegradable packaging laminate possessing superior oxygen gas barrier properties according to the present invention. Finally, still a further object of the present invention is to realise a liquid-tight biodegradable packaging container possessing superior oxygen gas barrier properties, produced from a packaging laminate according to the present invention.

### SOLUTION

These and other objects will be attained by means of a laminated packaging material possessing the characterizing features as set forth in appended claim 1. Preferred embodiments of the packaging laminate according to the present invention are apparent from appended subclaims 2 to 14.

The method according to the present invention carries the characterizing features as set forth in appended independent claim 15. Variations and modifications of the method according to the present invention are apparent from appended subclaims 16 to 19.

A packaging container according to the present invention carries the characterizing features as set forth in appended claims 20 and 21, respectively.

### OUTLINE OF THE INVENTION

Such a packaging laminate comprises at least one outer laver of biodegradable and thermosealable polvmers possessing superior liquid barrier properties, selected from among the group consisting essentially of homopolymers or copolymers of monomers in turn selected from a group consisting of lactic acid, glycol acid, lactide, glycolide, hydroxy butyric acid, hydroxy valeric acid, hydroxy caproic acid, valerolactone, butyrolactone and caprolactone. The outer lavers mav also include mixtures of these polymers. Preferably, the liquid barrier laver includes homopolymers or copolymers of lactic acid, lactide, glycol acid, glycolide, polyhydroxy butyrate, polyhydroxy valerate, hydroxv caproic acid or caprolactone, as, for example, a copolymer of lactic acid and caprolactone, or a copolymer of lactic acid and glycol acid. In a most preferred embodiment, the liquid barrier layer substantially consists of polylactide or polylactic acid, including copolymers of poly-L-lactic acid and poly-D-lactic acid.

Polylactide is a readilv available material which is well suited as moisture or liquid barrier in a packaging laminate. On the action of microorganisms freely occurring in nature, it is biodegradable to almost 100 percent and is moreover thermosealable, which makes polylactide particularly attractive as material in the outer layer of the packaging laminate for the production of tight and mechanically strong and durable sealing joints by thermosealing during the reforming of the packaging laminate into packages.

Additives known to a person skilled in the art to the polymers included in the liquid barrier layer such as, for example, plasticizers, may be employed according to the present invention, on condition that they have no negative effects on the packed product and that they do not prevent biodegradation of the packaging material or give rise to environmentally unacceptable substances on biodegradation.

Further, such a packaging laminate includes an oxygen gas barrier layer comprising a biodegradable polymer such as ethylene vinyl alcohol (EVOH) copolymer (proportion of ethylene approx. 20-50 mol percent ), polyvinyl alcohol (PVOH), starch or starch derivatives. According to one preferred embodiment, the oxygen gas barrier layer includes PVOH with a degree of hydrolysis of at least 90 percent. PVOH is a polymer displaying good biodegradability and possessing extremely good oxygen gas barrier properties. In relation to EVOH, PVOH displays better biodegradability and roughly ten times better oxygen gas barrier properties at the same time as appreciably better bonding or adhesive properties can be achieved. In addition, PRIOH is more economical than EVOH.

Outer liquid barrier layers in a laminate protect an interjacent oxvgen gas barrier layer against moisture and liquid, which would otherwise negatively affect its oxygen gas barrier properties. In order further to increase the resistance of the oxygen gas barrier laver to moisture attack, a cross linking agent may also be added. Suitable cross linking agents for EVOH or PVOH are dialdehydes such as, for example, glyoxal or glutaraldehyde, as well as acid anhydrides. A combination consisting of a polysaccharide such as, for example, chitosan and a dialdehyde or acid anhydride may also be added to achieve cross linking of EVOH or PVOH, as has been described in Danish Patent Application No. 1451/95. Other suitable cross linking agents are well known to persons skilled in the art.

The cross linking agent is added to the oxygen gas barrier layer preferably in a quantity corresponding to approx. 0.5-20 mol percent and more preferably in a quantity corresponding to approx. 0.5-10 mol percent.

By a special manner of applying the above-mentioned oxygen gas barrier layer in the form of an aqueous dispersion of the polymer included in the oxygen gas barrier layer onto a liquid barrier layer of a biodegradable polymer, preferably by means of a dispersion coating process and subsequent drying to the desired moisture content, unexpectedly good adhesion will be obtained between the two layers. Furthermore, by means of said method a verv thin but still homogeneous and evenly distributed layer of the gas barrier polymer may be applied. Thus, excellent gas barrier properties may be achieved even with quantities of gas barrier polymers as small as 1-10 g/m2.

Further improved adhesion may be achieved by the admixture of an adhesive in the oxygen gas barrier layer or by applying intenacent layers of adhesive between the layers. Examples of a suitable biodegradable adhesive according to the present invention are ethylene vinyl acetate (EVA) or polyvinyl acetate (PVAc). The admixture of the adhesive in the oxygen gas barrier layer preferably takes place in a quantity of up to 50 weight percent, most preferably 20-30 weight percent. An inteijacent adhesive laver is applied preferablv in the form of an aqueous dispersion, most preferably by means of a dispersion coating process with subsequent drying.

The packaging laminate according to the present invention may also include a biodegradable, compostable core layer of a cellulose-based fibre material, such as, for example, paper or paperboard, or of a biopolymer. The term “biopolymer” is taken to signify the previously mentioned biodegradable polymers suitable for the liquid barrier laver, but also other biodegradable polymers known to a person skilled in the art. Such biopolymers may be aliphatic polyesters or starch-based materials. The biopolymer employed in the core layer may be of homogeneous or foamed or expanded structure.

### BRIEF DESCRIPTION OF THE ACCOMPANYING DRAWINGS

The above-mentioned aspects of the present invention will now be described in greater detail hereinbelow, with particular reference to the accompanying Drawings, in which:

FIG. 1 schematically illustrates a cross section of one example of an embodiment of a packaging laminate according to the present invention;

FIG. 2 schematically illustrates one embodiment of a packaging laminate according to the present invention including a core layer; and

FIGS. 3a and 3b schematically illustrate two alternative methods of producing a packaging laminate according to the embodiment of the present invention illustrated in FIG. 1.

While the present invention will be described in greater detail hereinbelow with reference to specific embodiments shown on the Drawings, it will be obvious to a person skilled in the art that different modifications and variations may be made without departing from the inventive concept as this is defined in the appended claims.

### DESCRIPTION OF PREFERRED EMBODINMENTS

Referring to the Drawings, FIG. 1 thus shows a cross section of one embodiment of a packaging laminate 10 according to the present invention. The packaging laminate 10 includes outer liquid barrier layers 11 and 13 and an oxygen gas barrier layer 12 applied between them.

The liquid barrier layers 11 and 13 preferably consist substantially of polylactide, and the layer 11 is preferably a prefabricated, commercially available polvlactide film.

The oxygen gas barrier layer 12 includes PVOH with a degree of hydrolysis of at least 90 percent. In order to increase the moisture resistance of the oxygen gas barrier laver, a cross linking agent in the form of glyoxal or glutaraldehyde has been added to the PVOH prior to application.

The PVOH gas barrier polymaer mav be replaced by a starch or starch derivative polvmer.

The oxygen gas barrier laver is preferably applied in a quantity corresponding to 1-10 g/m², more preferably 3-5 g/m².

The oxygen gas barrier layer 12 and the outer liquid-tight lavers 11 and 13, respectively, may be directlv bonded to one another or indirectly bonded by means of interiacent layers of adhesive 14, 15, respectively of, for example, EVA or PVAc. Such an inteijacent layer of adhesive further improves adhesion and strength in the packaging laminate and is preferably applied in a quantitv corresponding to approx. 0.5-5 g/m². Alternatively, an adhesive such as, for example, EVA or PVAc may be admixed into the oxygen gas barrier laver in order to increase its adhesive capability to adjacent layers, preferably in a quantity of up to 50 weight percent, most preferably 20-30 weight percent.

FIG. 2 shows a cross section of one embodiment of a packaging laminate 20 according to the present invention. The packaging laminate 20 includes an outer liquid barrier layer 11 and an oxygen gas barrier layer 22 with the same ingredients as the layers 11 and 12, respectively in FIG. 1. The liquid barrier layer coated with the oxygen gas barrier layer is laminated to a core laver of paper or paper board 23 by means of an interjacent adhesive layer 24 of PVAc or EVA. The adhesive layer is applied in a quantity corresponding to approx. 0.5-5 g/m² to bond the coated plastic film and the paperboard to each other.

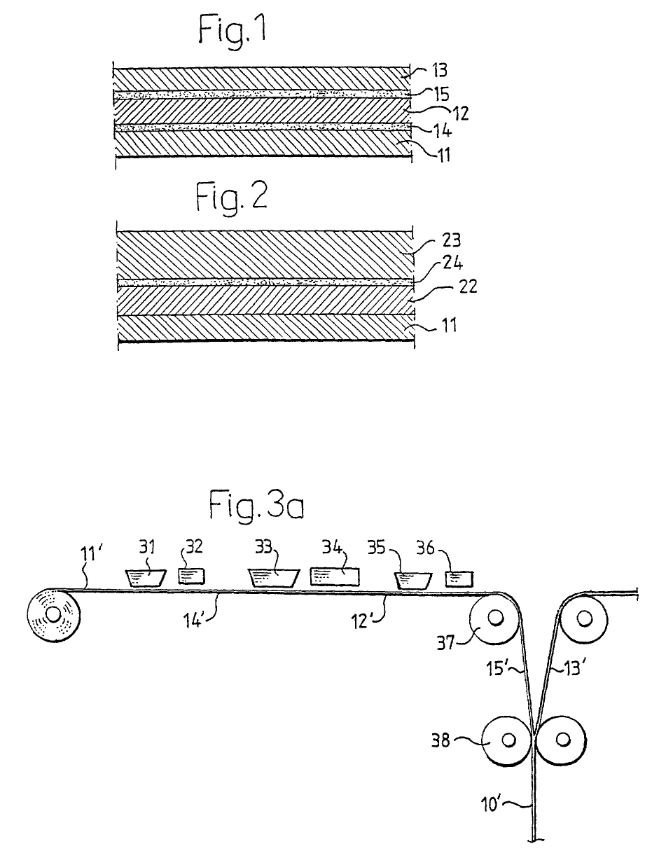

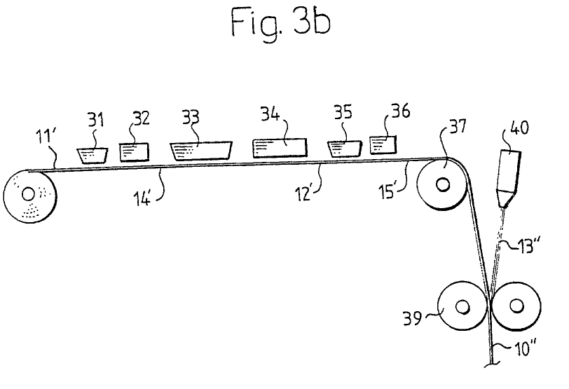

The packaging laminate 10 in FIG. 1 may, according to the present invention, be produced in the manner which is schematicallv illustrated in FIG. 3a or alternatively 3b. The same reference numerals, carrying an additional primo (′) or secundo (″) svmbol have been used in FIG. 3 as in FIG. 1 in order to facilitate a comparison between the architecture of the packaging laminate and its production.

A web of a prefabricated film of a biodegradable polvmer, preferably polylactide 11′, is unreeled from a magazine reel and led past an applicator 31 disposed adjacent the web, with the aid of which applicator the web is covered, preferably by coating, with an aqueous dispersion of a biodegradable adhesive, such as, for example, EVA or PVAc, in a thin continuous layer. The aqueous dispersion is applied to the web 11′ in a quantity corresponding to 0.5-5.0 g/m² which, according to the present invention, is an optimum application quantitv to achieve the best possible bonding strength between the lavers in the packaging laminate.

The web coated with adhesive dispersion is thereafter dried by means of a drier apparatus 32 acting on the treated side of the web, for example and IR drier (infrared radiation) or a hot air unit for driving off (evaporating) water so that the moisture content of the applied adhesive layer is set at a suitable level.

The dried web 14′ is then led further to be covered, preferably by a coating process, at 33, with an aqueous dispersion of a biodegradable polymer possessing superior oxygen gas barrier properties, such as PVOH. The aqueous dispersion is applied on the web 14′ in a quantity corresponding to 1-10 g/m², preferably 3-5 g/m² and is thereafter dried bv means of a drier apparatus 34 acting on the treated side of the web, this apparatus being the same type—or any other suitable type—as the above drier apparatus 32, setting a suitable moisture content in the oxygen gas barrier layer 12. The web 12′ coated with the oxygen gas barrier layer is then covered, preferably by a coating process, at 35, with an aqueous dispersion of EVA or PVAc, as at 31, in a quantity corresponding to 0.5-5.0 g/m² in order subsequently to be dried at 36 in the same manner as at 32.

The thus obtained web 15′ may finally be laminated with a liquid barrier layer of polylactide in substantially two alternative methods.

FIG. 3a shows how the web 15′ is led via a bending roller 37 through a heated roller nip 38 and is simultaneously united with a web of a prefabricated polvlactide film 13′, the two webs 15′ and 13′ being thermolaminated to one another and permanently bonded to one another by surface fusion under the supplv of heat and pressure on passage through the nip between the heated rollers 38 for the formation of the packaging laminate 10′.

FIG. 3b shows, alternatively, how the web 15′ coated with oxygen gas barrier layer 12 and adhesive layers 14 and 15, is led via a bending roller 37 through the heated roller nip 39, at the same time as a thin continuous layer 13″ of biodegradable or compostable material, preferably polylactide, is extruded bv means of an extruder 40 onto the upper face of the web 15′ for the formation of a well-integrated web-shaped packaging laminate 10″.

The thermolaminated w eb 10′ or the extrusion coated web 10″, respectively, may thereafter be wound up onto a magazine reel (not shown) for further transport and handling, or be led straight into a packing and filling machine.

The packaging laminate according to the present invention may be formed into packaging containers by conventional tube or fold forming. Moreover, the packaging laminate according to the present invention is well suited for thermoforming. Different fold formation, sealing and thermoforming processes are known to persons skilled in the art and are adapted to the packaging laminate according to the present invention in accordance with known techniques.

After use and emptying of a packaging container according to the present invention, it can be composted in an enviromnentally acceptable manner by biodegradation, without forming environmentally unacceptable degradation products. In order to promote degradation or composting of a packaging container according to the invention, it may be comminuted or disintegrated by other means in order to facilitate access for moisture and micro-organisms to the packaging material.

As will have been apparent from the foregoing description, the objects established may readily and efficiently be attained according to the present invention using readily available materials and existing techniques and equipment for the production of a packaging laminate possessing superior liquid- and oxygen gas barrier properties in which all components included are biodegradable. The packaging laminate displays good adhesion between the different layers included, superior thermosealing properties and retained superior oxygen gas barrier properties even under the attack of moisture and liquid. Furthermore, the present invention realises a method of producing the biodegradable packaging laminate according to the invention, as wetell as a biodegradable packaging container produced from the packaging laminate according to the invention.

What is claimed is:

1. A packaging laminate (10; 20) comprising at least one liquid-tight layer (11) and one oxygen gas barrier layer (12), characterized in that all layers included in the packaging laminate are biodegradable.

2. The packaging laminate as claimed in claim 1, characterized in that said liquid-tight layers (11, 13) include a homopolymer or a copolymer of monomers selected from a group consisting of lactic acid, glycol acid, lactide, glycolide, hydroxv butyric acid, hydroxy valeric acid, hydroxy caproic acid, valerolactone, but,,rolactone and caprolactone.

3. The packaging laminate as claimed in claim 1 or 2, characterized in that said liquid-tight layers (11, 13) include a polymer selected from a group consisting of polylactide homopolvmer and polNlactide copolymer.

4. The packaging laminate as claimed in any of claims 1 to 3, characterized in that said oxygen gas barrier layer (12) includes a polvmer selected from a group consisting of polyvinyl alcohol, starch and starch derivatives.

5. The packaging laminate as claimed in claim 4, characterized in that said polyvinyl alcohol has a degree of hvdrolvsis of at least 90 percent.

6. The packaging laminate as claimed in claim 4 or 5, characterized in that said oxygen gas barrier layer (12) including polyvinyl alcohol also includes a cross linking agent.

7. The packaging laminate as claimed in any of claims 4 to 6, characterized in that said ox7gen gas barrier layer (12) also includes a biodegradable adhesive.

8. The packaging laminate as claimed in any of claims 4 to 7, characterized in that a layer of a biodegradable adhesive (14 and 15, respectively) is disposed between said oxygen gas barrier layer (12) and said liquid barrier layers (11, 13, respectively).

9. The packaging laminate as claimed in claim 7 or 8, characterized in that said adhesive is selected from a group consisting of ethylene vinyl acetate and polyvinyl acetate.

10. The packaging laminate as claimed in any of the preceeding claims, characterized in that said oxygen gas barrier layer (12) has been applied by means of dispersion coating.

11. The packaging laminate as claimed in any of the preceeding claims, characterized in that said oxygen gas barrier layer (12) has been applied in a quantity of 1-10 g/m2.

12. The packaging laminate (20) as claimed in any of the preceding Claims, characterized in that in addition to said liquid barrier layer (11) and oxygen gas barrier layer (12), it includes a core layer (23) of a biodegradable material.

13. The packaging laminate as claimed in claim 12, characterized in that said core layer (23) consists of paper or paperboard.

14. The packaging laminate as claimed in claim 12, characterized in that said core layer (23) consists of a foamed or expanded biopolymer.

15. A method of producing a biodegradable packaging laminate according to any of claims 1 to 14, characterized in that said oxygen gas barrier layer (12) is applied on a prefabricated biodegradable liquid barrier layer (11) by a coating process.

16. The method as claimed in claim 15, characterized in that the oxygen gas barrier layer (12) bonded to said liquid barrier layer (11) is covered wVith a prefabricated, second biodegradable liquid barrier layer (13) by means of thermolamination.

17. The method as claimed in claim 15, characterized in that the oxygen gas barrier layer (12) bonded to said liquid barrier layer (11) is covered with a second biodegradable liquid barrier layer (13) by means of extrusion.

18. The method as claimed in claim 15, characterized in that a layer of an adhesive (14) is applied on said prefabricated biodegradable liquid barrier layer (11) by means of coating and is dried; and that an oxygen gas barrier layer (12) is thereafter applied on the liquid barrier layer (11/14) covered with adhesive, by means of a coating process.

19 The method as claimed in claim 16 or 17, characterized in that a layer of an adhesive (15) is applied on the oxygen gas barrier layer (12) bonded to said liquid barrier laver (11) by means of coating and is dried; and that said adhesive laver (15) is thereafter coated with said second liquid barrier layer (13)

20. A liquid-tight biodegradable packaging container possessing superior oxygen gas barrier properties, produced from a packaging laminate according to anv of claims 1 to 14.

21. A liquid-tight biodegradable packaging container possessing superior oxygen gas barrier properties, produced by thermofornming of a packaging laminate according to any of claims 1 to 14.
